(19) United States
(12) Patent Application Publication
(10) Pub. No.: US 2017/0225684 A1
(43) Pub. Date: Aug. 10, 2017

(54) WHEEL EQUIPPED WITH MULTIPLE HUB MOTORS

(71) Applicant: OTHMAN MOHAMMED S. ALSHAMRANI, Seattle, WA (US)

(72) Inventor: OTHMAN MOHAMMED S. ALSHAMRANI, Seattle, WA (US)

(21) Appl. No.: 15/015,520

(22) Filed: Feb. 4, 2016

(51) Int. Cl. B60W 30/18; B60W 30/188; B60K 26/02; B60W 10/08; B60K 1/02; B60K 7/00

(52) U.S. Cl. CPC B60W 30/18145; B60K 1/02; B60K 7/0007; B60K 26/021; B60W 10/08; B60W 30/188; B60K 2026/025

(57) ABSTRACT

A system for electrically driving a vehicle comprising an energy storage device connected to a master controller, an axle connected to the vehicle, at least one bearing concentrically and rotatably connected to the axle, a wheel concentrically connected to the at least one bearing, a tire concentrically connected to the wheel, a wheel motor assembly comprising at least two electric motors concentrically connected to the axle, and a wire harness connected to a first motor controller, a second motor controller, and the master controller. Operator input provides an input to the master controller to provide electrical power from the energy storage device through the wire harness to at least one of the first motor controller and the second motor controller, driving the wheel motor assembly, rotating the wheel and the tire about the axle, and providing propulsion to the vehicle.

### BACKGROUND

Field of the Disclosure

The present disclosure is directed toward a wheel equipped with multiple hub mounted electric motors for propulsion.

Description of the Related Art

Some current electric and hybrid-electric vehicles have in-wheel hub motors to provide propulsion and regenerative braking capability. The design and methods of operation of existing in-wheel hub motors present a variety of opportunities for improvement to enhance the overall performance of vehicles equipped with in-wheel hub motors over a wide range of operating conditions. Moreover, some vehicle types or applications that may not presently be well-suited to using in-wheel hub motors could become better suited for propulsion by in-wheel hub motors with novel features and control methods.

### SUMMARY

The present disclosure is directed to a system for electrically driving a vehicle comprising an energy storage device connected to a master controller, an axle connected to the vehicle, at least one bearing concentrically and rotatably connected to the axle, a wheel concentrically connected to the at least one bearing, a tire concentrically connected to the wheel, a wheel motor assembly comprising at least two electric motors concentrically connected to the axle, and a wire harness connected to a first motor controller, a second motor controller, and the master controller. Operator input provides an input to the master controller to provide electrical power from an energy storage device through the wire harness to at least one of the first motor controller and the second motor controller, driving the wheel motor assembly, rotating the wheel and the tire about the axle, and providing propulsion to the vehicle.

Further, the disclosure is directed to a method for electrically operating a vehicle equipped with a wheel motor assembly having at least one motor. The method comprises the steps of determining the speed of the vehicle and the magnitude of displacement of a first speed control device and a second speed control device, comparing available combinations of motors in the wheel motor assembly to operate the vehicle, selecting a combination of motors to operate corresponding to the displacement of the speed control devices, and operating the selected combination of motors within the wheel motor assembly.

The terms regenerate and generate, and their variations, are used interchangeably throughout this disclosure to mean a motor 6 operating in a mode to produce electrical power.

The foregoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein:

FIG. 1 is a side view of an example embodiment of a vehicle 1 equipped with a wheel motor assembly;

FIG. 2A is a front section view of an example embodiment of an outer rotation type wheel motor assembly connected to a chassis member;

FIG. 2B is a side section view of an example embodiment of a wheel motor assembly;

FIG. 2C is a front section view of an example embodiment of an inner rotation type wheel motor assembly connected to a chassis member;

FIG. 2D is a front section view of an example embodiment of a wheel assembly connected to a chassis member;

FIG. 3 is a front section view of an example embodiment of a wheel motor assembly equipped with two equal sized motors;

FIG. 4 is a front section view of an example embodiment of a wheel motor assembly equipped with two unequal sized motors;

FIG. 5 is a front section view of an example embodiment of a wheel motor assembly equipped with three unequal sized motors;

FIG. 6A is a front section view of an example embodiment of a wheelset equipped with two wheel motor assemblies;

FIG. 6B is a front section view of an example embodiment of a wheelset equipped with one wheel motor assembly and one wheel assembly;

FIG. 7 is a side profile view of an example embodiment of a speed control device;

FIG. 8 is a diagram of an example vehicle system including two wheel motor assemblies; and

FIG. 9 is a diagram representing a sequence of primary processes of a wheel motor assembly control method for controlling at least one wheel motor assembly or wheelset.

### DETAILED DESCRIPTION OF THE EMBODIMENTS

In the drawings, like reference numerals designate identical or corresponding parts throughout the several views. Further, as used herein, the words “a”, “an” and the like generally carry a meaning of “one or more”, unless stated otherwise.

Referring now to the drawings, wherein like reference numerals designate identical or corresponding parts throughout the several views.

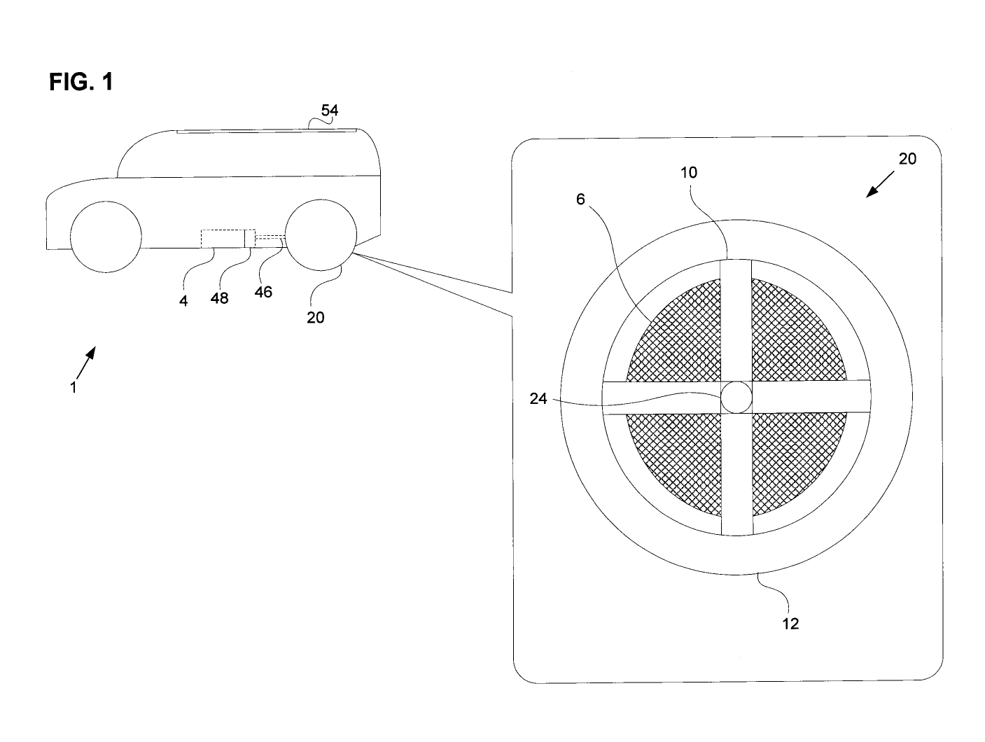

FIG. 1 is a side view of an example embodiment of a vehicle 1 equipped with a wheel motor assembly. The vehicle 1 includes an energy storage device 4, a wheel motor assembly 20, a wire harness 46, and a master controller 48. The wheel motor assembly 20 comprises a wheel 10, an axle 24, a motor 6, and a tire 12. The tire 12, the wheel 10, and the motor 6 are concentrically mounted about the axle 24, with the wheel 10 and the tire 12 rotatably connected to the axle 24. The energy storage device 4 is connected to the master controller 48, and the wire harness 46 is connected to the master controller 48 and the motor 6, allowing the master controller 48 to transmit electrical power through the wire harness 46 to the wheel motor assembly 20. Electrical power for the wheel motor assembly 20 is provided by the energy storage device 4 through the master controller 48. The wheel motor assembly 20 is exemplary of the background art and may represent a variety of wheel motor assembly 20 types, such as those having Alternating Current (AC) or Direct Current (DC), and types of wheel motor designs such as inner rotation types and outer rotation types.

In another example, the energy storage device 4 may also be connected to additional sources of power such as an array of solar cells 54 connected to an exterior surface of the vehicle 1 such as the roof of the vehicle 1.

In another example, the

Further, the master controller 48 monitors the State of Charge (SOC) of the energy storage device 4. If the SOC falls below a threshold, such as 25 percent, the master controller 48 alerts the driver to the need for recharging.

The motor 6 and the wheel 10 described herein may be installed on a vehicle 1 that may also have other sources of propulsion, such as internal combustion engines powered by gasoline or diesel, or the vehicle 1 may be powered purely by electricity. In a case where the vehicle 1 also has other sources of propulsion, use of one or more motors can offset the fuel needed by an internal combustion engine and reduce fuel consumption.

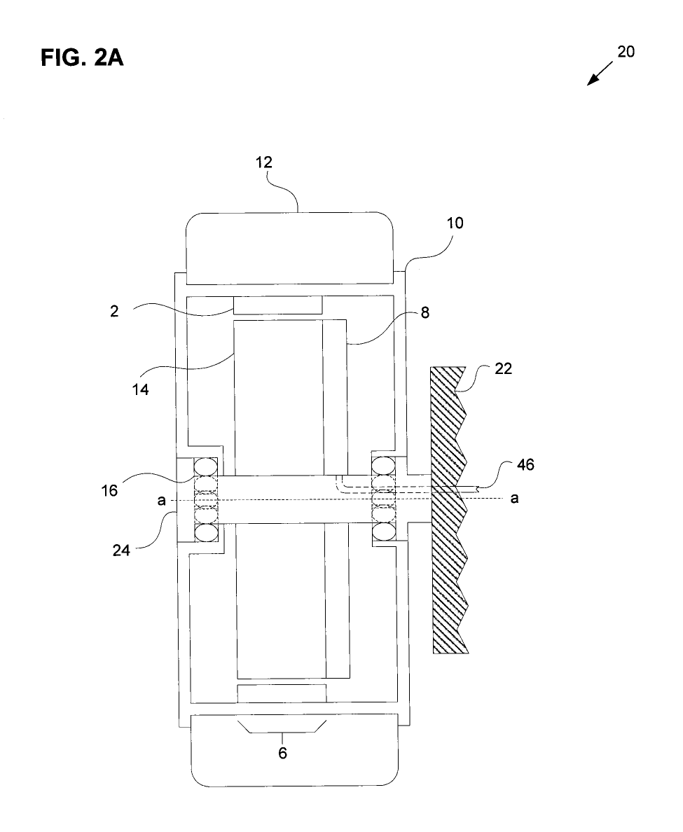

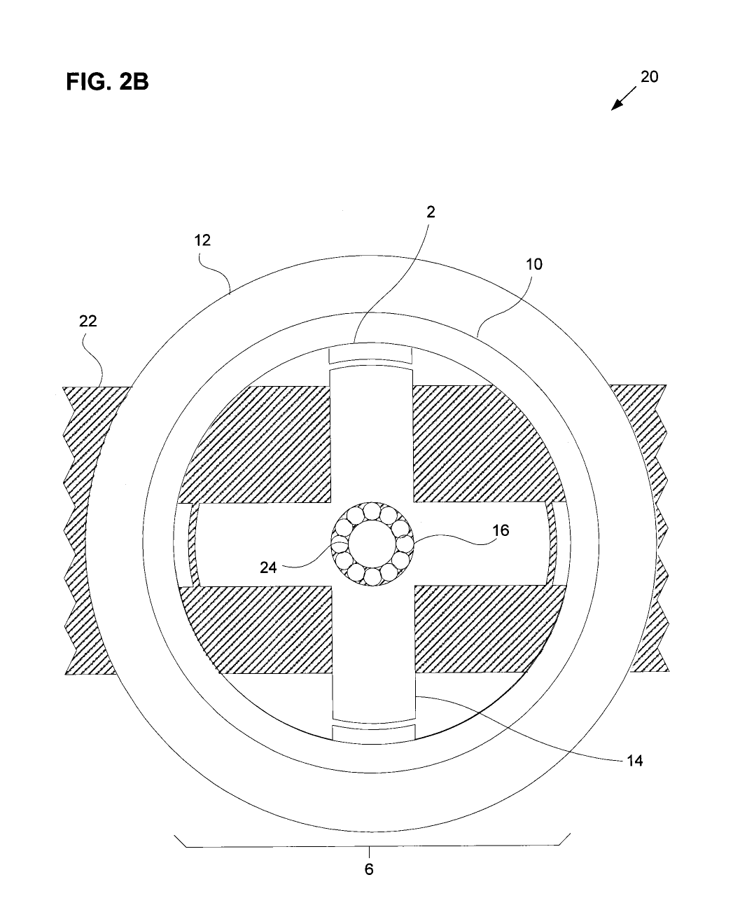

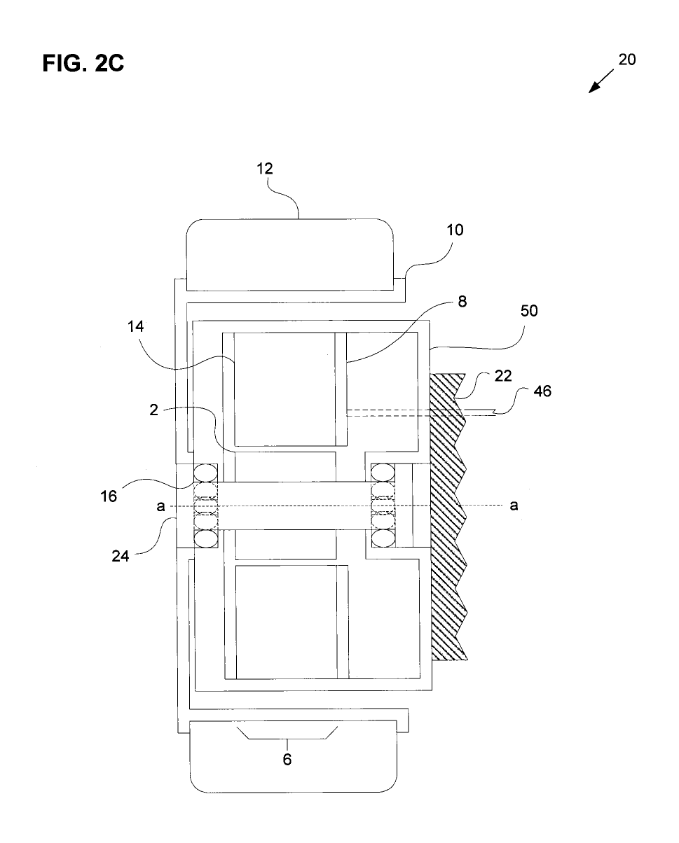

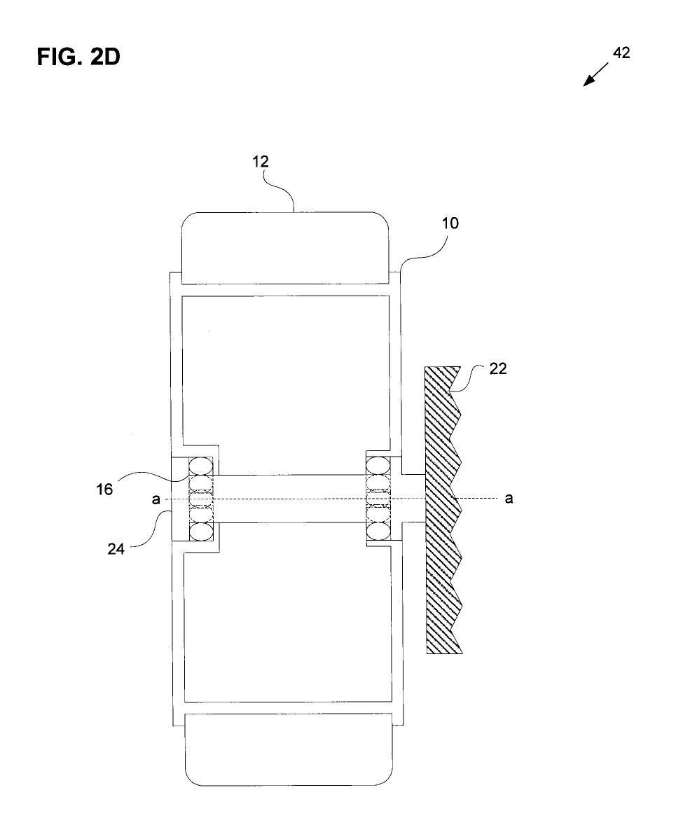

FIG. 2A is a front section view of an example embodiment of an outer rotation type wheel motor assembly 20 connected to a chassis member 22. The chassis member 22 is a part of the structure of, and connected to the vehicle 1 of FIG. 1. The wheel motor assembly 20 is an outer rotation type, with an axle 24 remaining stationary and the wheel 10 rotating about the axle 24.

The wheel motor assembly 20 comprises the axle 24, at least one bearing 16, a plurality of magnets 2, a motor controller 8, a stator 14, the wheel 10, the tire 12, and the wire harness 46. The stator 14 and the motor controller 8 are centered about and rigidly connected to the axle 24. The axle 24 is rigidly connected to the chassis member 22. A first end of the wire harness 46 is connected to the master controller 48 (FIG. 1) and a second end of the wire harness 46 is disposed within the axle 24 and connected to the motor controller 8. The wheel 10 is connected to and supported by the at least one bearing 16, and both the at least one bearing 16 and the wheel 10 are concentrically connected and rotate about the axle 24. The plurality of magnets 2 are connected to an inside diameter of the wheel 10, disposed similarly along the longitudinal axis a-a of the axle 24 as the stator 14, such that the plurality of magnets 2 rotate with the wheel 10 concentrically about the axle 24 and the stator 14. Further, the tire 12 is concentrically connected to the wheel 10.

The stator 14 and the plurality of magnets 2 form a motor 6. Electrical power provided to the motor 6 through the wire harness 46 allows rotation of the plurality of magnets 2 about the stator 14, with the motor controller 8 controlling the application of electrical power provided to the motor 6. As the motor 6 receives sufficient electrical power to rotate, the wheel 10 and tire 12 also rotate and provide propulsion to the chassis member 22 of the vehicle 1 to which the wheel motor assembly 20 is connected. In other embodiments the axle 24 may be connected directly to the vehicle 1.

A motor converts electrical power into mechanical motion, and may also serve as a generator by converting mechanical motion into electrical power by operating in a reverse mode.

Further, the physical dimensions of a motor 6, including diameter and axial length, influence the performance characteristics of the motor 6. While the motor 6 diameter and axial length are not the only factors that influence the motor 6 performance. In general, the motors 6 with larger diameters may produce higher torque outputs and the motors 6 with longer axial lengths may be capable of operating at higher rotational speeds more efficiently.

FIG. 2B is a side section view of an example embodiment of a wheel motor assembly 20. The wheel motor assembly 20 is connected to a chassis member 22. The chassis member 22 is a part of the structure of, and connected to the vehicle 1 of FIG. 1. The wheel motor assembly 20 comprises the axle 24, the at least one bearing 16, the plurality of magnets 2, the stator 14, the wheel 10, and the tire 12 described by FIG. 2A.

FIG. 2C is a front section view of an example embodiment of an inner rotation type wheel motor assembly 20 connected to a chassis member 22. The wheel motor assembly 20 comprises an axle 24, at least one bearing 16, a plurality of magnets 2, a motor controller 8, a stator 14, a wheel 10, a tire 12, a wire harness 46, and a frame member 50. The stator 14 and the motor controller 8 are centered about and rigidly connected to the frame member 50, and the frame member 50 is rigidly connected to the chassis member 22. The axle 24 is rotatably connected to the frame member 50 by the at least one bearing 16. The wheel 10 is connected to and supported by the at least one bearing 16, and the wheel 10 centered about, rigidly connected to, and rotates with the axle 24. The plurality of magnets 2 are rigidly connected to the axle 24, disposed similarly along the longitudinal axis a-a of the axle 24 as the stator 14 such that the plurality of magnets 2 rotate concentrically with the axle 24 and the wheel 10. Further, the tire 12 is concentrically connected to the wheel 10. A first end of the wire harness 46 is connected to the master controller 48 (FIG. 1) and a second end of the wire harness 46 is connected to the motor controller 8, allowing the energy storage device 4 (FIG. 1) to provide electrical power to the motor 6 through the wire harness 46.

FIG. 2D is a front section view of an example embodiment of a wheel assembly 42 connected to a chassis member 22. The chassis member 22 is a part of the structure of, and connected to the vehicle 1 of FIG. 1. The wheel assembly 42 is similar to the wheel motor assembly 20 except that it does not have a motor 6, and the associated parts and connection. The wheel assembly 42 provides support and rotation but does not possess propulsion power or regenerative braking capability.

The wheel assembly 42 comprises an axle 24, at least one bearing 16, a wheel 10, and a tire 12. The axle 24 is rigidly connected to the chassis member 22. The wheel 10 is connected to and supported by the at least one bearing 16, and both the at least one bearing 16 and the wheel 10 are concentrically connected and rotate about the axle 24. Further, the tire 12 is concentrically connected to the wheel 10.

A wheel assembly 42 that further comprises a motor controller 8, a plurality of magnets 2, a stator 14, and a wire harness 46 as described by FIG. 2A is the same as a wheel motor assembly 20.

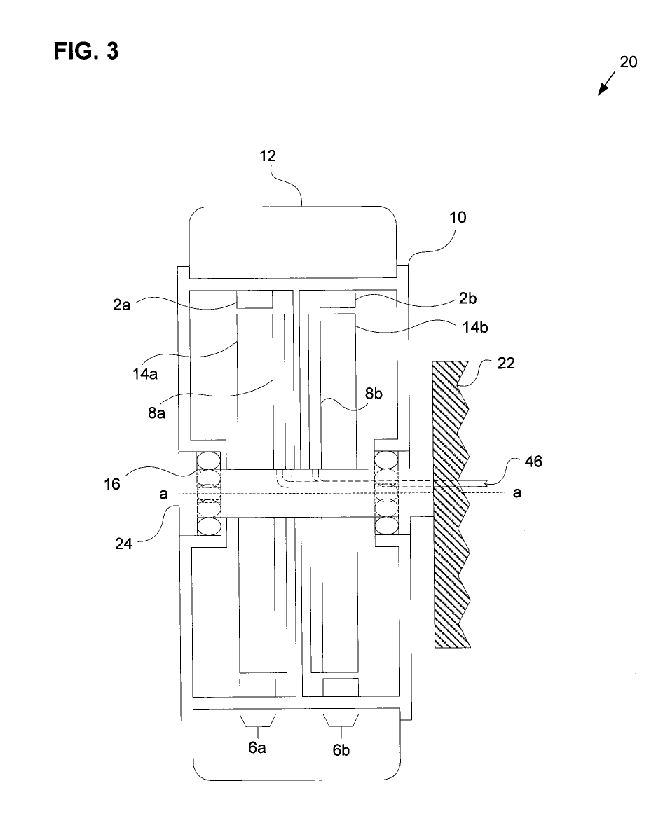

FIG. 3 is a front section view of an example embodiment of a wheel motor assembly 20 equipped with two equal sized motors 6a, 6b. The wheel motor assembly 20 is connected to a chassis member 22, the wheel motor assembly 20 comprising an axle 24, at least one bearing 16, a plurality of magnets 2a, a plurality of magnets 2b, a motor controller 8a, a motor controller 8b, a stator 14a, a stator 14b, a wheel 10, a tire 12, and a wire harness 46.

The motor controller 8a is rigidly connected to the stator 14a, the motor controller 8b is rigidly connected to the stator 14b, and each is centered about and rigidly connected to the axle 24. The axle 24 is rigidly connected to the chassis member 22 and does not rotate. In another example, the motor controllers 8a and 8b may be disposed on the chassis member 22 or elsewhere on the vehicle 1 rather than within the wheel motor assembly 20, and electrically connected to the stators 14a and 14b, respectively. The wheel 10 is connected to and supported by the at least one bearing 16, and both the at least one bearing 16 and the wheel 10 are concentrically connected and rotate about the axle 24. The plurality of magnets 2a and the plurality of magnets 2b are connected to an inside diameter of the wheel 10, disposed similarly along the longitudinal axis a-a of the axle 24 as the stator 14a and the stator 14b such that the plurality of magnets 2a and the plurality of magnets 2b rotate with the wheel 10 concentrically about the axle 24, the stator 14a, and the stator 14b, respectively. The tire 12 is concentrically connected to the wheel 10. A first end of the wire harness 46 is connected to a master controller 48 (FIG. 1) and a second end and a third end of the wire harness 46 are disposed within the axle 24 and connected to the motor controller 8a and the motor controller 8b, respectively.

The stator 14a and the plurality of magnets 2a form a motor 6a. The motor controller 8a regulates the direction of rotation and magnitude of electrical power directed to the motor 6a based on input from a speed control device 36. Electrical power provided to the motor 6a through the wire harness 46 may create an alternating magnetic field between the plurality of magnets 2a and the stator 14a, resulting in rotation of the plurality of magnets 2a about the stator 14a. The stator 14b and the plurality of magnets 2b form a motor 6b. Similarly, electrical power provided to the motor 6b through the wire harness 46 results in rotation of the plurality of magnets 2b about the stator 14b. As one or both the motor 6a and the motor 6b receive sufficient electrical power to rotate, the wheel 10 and tire 12 also rotate and provide propulsion to the chassis member 22 of the vehicle 1. The motor 6a and the motor 6b may operate synchronously or asynchronously.

In this embodiment the wheel motor assembly 20 is an outer rotation type design, and the motor 6a and the motor 6b are identical in size and design.

In one example, the wheel motor assembly 20 may accelerate by applying an equal amount of electrical power to each of the motor 6a and the motor 6b.

In another example, the wheel motor assembly 20 may accelerate by applying an amount of electrical power to only one of the motor 6a or the motor 6b.

In another example, the wheel motor assembly 20 may accelerate by applying a first and a second amount of electrical power to the motor 6a and the motor 6b, respectively, where the first and second amounts may not be equal in magnitude and may be applied asynchronously.

In another example, the wheel motor assembly 20 may operate at steady state by applying an equal amount of electrical power to each of the motor 6a and the motor 6b.

In another example, the wheel motor assembly 20 may operate at steady state by applying an amount of electrical power to only one of the motor 6a or the motor 6b.

In another example, the wheel motor assembly 20 may operate at a steady state by applying different magnitudes of electrical power to the motor 6a and the motor 6b.

In another example, the wheel motor assembly 20 may decelerate from a speed using regenerative braking where each of the motor 6a and the motor 6b operate as a generator to produce an equal amount of electrical power and charge an energy storage device 4 (FIG. 1).

In another example, the wheel motor assembly 20 may decelerate from a speed using regenerative braking where only one of the motor 6a or the motor 6b operate as a generator to produce electrical power and charge the energy storage device 4.

In another example, the wheel motor assembly 20 may decelerate from a speed using regenerative braking where each of the motor 6a and the motor 6b operate as a generator to produce differing magnitudes of electrical power and charge the energy storage device 4.

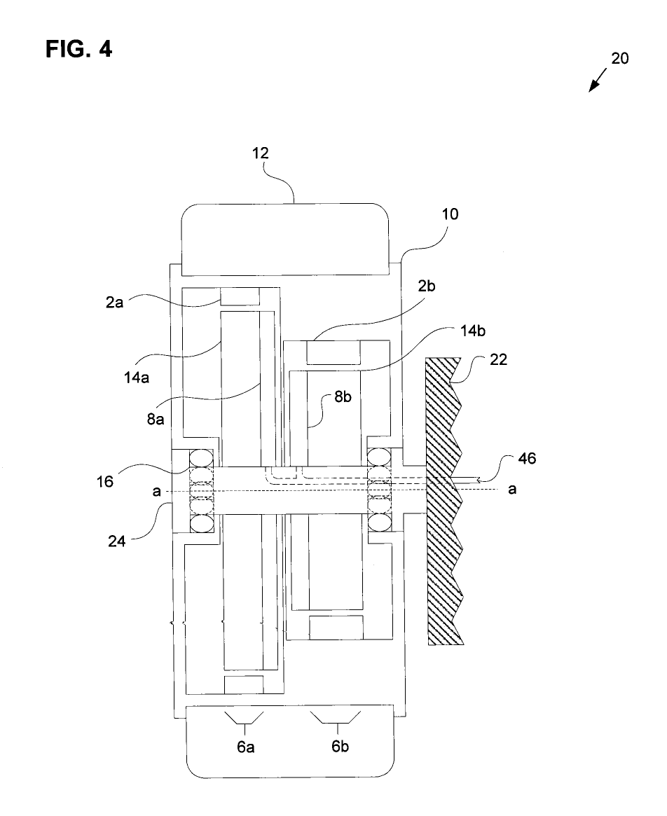

FIG. 4 is a front section view of an example embodiment of a wheel motor assembly 20 equipped with two unequal sized motors 6. The wheel motor assembly 20 is connected to a chassis member 22, the wheel motor assembly 20 comprising an axle 24, at least one bearing 16, a plurality of magnets 2a, a plurality of magnets 2b, a stator 14a, a stator 14b, a motor controller 8a, a motor controller 8b, a wheel 10, a tire 12, and a wire harness 46. The wheel motor assembly 20 is similar to the embodiment described by FIG. 3.

The stator 14a and the plurality of magnets 2a form a motor 6a. Electrical power provided to the motor 6a through the wire harness 46 results in rotation of the plurality of magnets 2a about the stator 14a. The stator 14b and the plurality of magnets 2b form a motor 6b. Electrical power provided to the motor 6b through the wire harness 46 results in rotation of the plurality of magnets 2b about the stator 14b. As one or both the motor 6a and the motor 6b receive sufficient electrical power to rotate, the wheel 10 and tire 12 also rotate and provide propulsion to the chassis member 22 of the vehicle 1. The motor 6a and the motor 6b may operate synchronously or asynchronously.

In this embodiment the wheel motor assembly 20 is an outer rotation type design, and the motor 6a and the motor 6b differ in size and design.

The difference between the embodiments of FIG. 3 and FIG. 4 is that the motor 6a and the motor 6b in FIG. 4 are not of identical size, such that the plurality of magnets 2a is connected to a first inner diameter of the wheel 10 and the plurality of magnets 2b is connected to a second inner diameter of the wheel 10, the first and second diameters of the wheel 10 having different dimensions.

The different diameters of the motor 6a and the motor 6b offer the advantage of providing a broader range of combined operating characteristics than the example of FIG. 3 under the same operating conditions described by FIG. 3 for acceleration, steady state operation, and deceleration through regenerative braking. For example, the motor 6a may offer greater low speed torque and the motor 6b may offer more efficient operation in a higher speed range.

Under certain operating conditions, operating one or both the motor 6a and the motor 6b during acceleration of the wheel motor assembly 20, maintaining steady state operation of the wheel motor assembly 20, and decelerating the wheel motor assembly 20 while regenerating electrical power may be more efficient than if both the motor 6a and the motor 6b are of identical size and design.

These advantages may be particularly helpful with fixed gear, in-wheel motor designs. A wheel motor assembly 20 with multiple motors 6 with different operating characteristics may better approximate some of the functions of a single motor 6 connected to a gearbox or transmission than a wheel motor assembly 20 with only one motor 6.

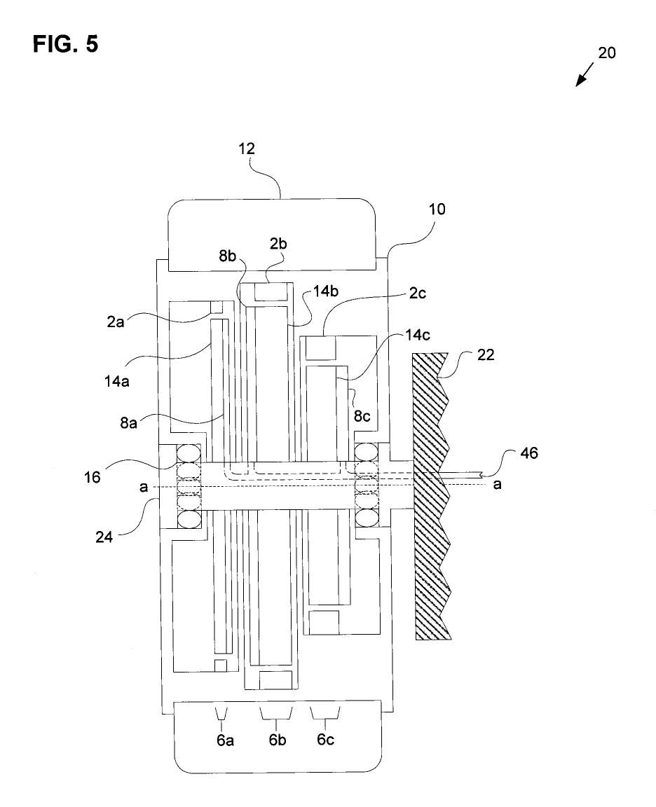

FIG. 5 is a front section view of an example embodiment of a wheel motor assembly 20 equipped with three unequal sized motors 6. The wheel motor assembly 20 is connected to a chassis member 22, the wheel motor assembly 20 comprising an axle 24, at least one bearing 16, a plurality of magnets 2a, a plurality of magnets 2b, a plurality of magnets 2c, a stator 14a, a stator 14b, a stator 14c, a motor controller 8a, a motor controller 8b, a motor controller 8c, a wheel 10, a tire 12, and a wire harness 46.

The motor controller 8a is rigidly connected to the stator 14a, the motor controller 8b is rigidly connected to the stator 14b, the motor controller 8c is rigidly connected to the stator 14c, and each is centered about and rigidly connected to the axle 24. The axle 24 is rigidly connected to the chassis member 22 and does not rotate. The wheel 10 is connected to and supported by the at least one bearing 16, and both the at least one bearing 16 and the wheel 10 are concentrically connected and rotate about the axle 24. The plurality of magnets 2a, the plurality of magnets 2b, and the plurality of magnets 2c are connected to a first, a second, and a third inner diameter of the wheel 10, respectively, all disposed similarly along the longitudinal axis a-a of the axle 24 as the stator 14a, the stator 14b, and the stator 14c, respectively, such that the plurality of magnets 2a, the plurality of magnets 2b, the plurality of magnets 2c, the wheel 10, and the tire 12 rotate concentrically about the axle 24, the stator 14a, the stator 14b, and the stator 14c. Further, the tire 12 is concentrically connected to the wheel 10. A first end of the wire harness 46 is connected to the master controller 48 (FIG. 1) and a second end, a third end, and a fourth end of the wire harness 46 are disposed within the axle 24 and connected to the motor controller 8a, the motor controller 8b, and the motor controller 8c, respectively.

The stator 14a and the plurality of magnets 2a form a motor 6a. Electrical power provided to the motor 6a through the wire harness 46 results in rotation of the plurality of magnets 2a about the stator 14a. The stator 14b and the plurality of magnets 2b form a motor 6b. Electrical power provided to the motor 6b through the wire harness 46 results in rotation of the plurality of magnets 2b about the stator 14b. The stator 14c and the plurality of magnets 2c form a motor 6c. Electrical power provided to the motor 6c through the wire harness 46 results in rotation of the plurality of magnets 2c about the stator 14c. As one or more of the group consisting of the motor 6a, the motor 6b, and the motor 6c receives sufficient electrical power to rotate, the wheel 10 and tire 12 also rotate and provide propulsion to the chassis member 22 of the vehicle 1. The motor 6a, the motor 6b, and the motor 6c may operate synchronously or asynchronously.

In this embodiment the wheel motor assembly 20 is an outer rotation type design, and the motor 6a, the motor 6b, and the motor 6c may vary in size and design, with varied inner diameters of the wheel 10 such as that of the embodiment of FIG. 4.

In one example, the wheel motor assembly 20 may accelerate by applying an equal amount of electrical power to each of the motor 6a, the motor 6b, and the motor 6c.

In another example, the wheel motor assembly 20 may accelerate by applying an amount of electrical power to at least one of the group consisting of the motor 6a, the motor 6b, and the motor 6c.

In another example, the wheel motor assembly 20 may accelerate by applying a first, a second, and a third amount of electrical power to the motor 6a, the motor 6b, and the motor 6c, respectively, where the first, the second, and the third amounts may not be equal in magnitude and may be applied asynchronously.

In another example, the wheel motor assembly 20 may operate at steady state by applying an equal amount of electrical power to each of the motor 6a, the motor 6b, and the motor 6c.

In another example, the wheel motor assembly 20 may operate at steady state by applying an amount of electrical power to at least one of the group consisting of the motor 6a, the motor 6b, and the motor 6c.

In another example, the wheel motor assembly 20 may operate at a steady state by applying different magnitudes of electrical power to at least one of the group consisting of the motor 6a, the motor 6b, and the motor 6c, and the electrical power may be applied asynchronously.

In another example, the wheel motor assembly 20 may decelerate from an operating speed using regenerative braking where each of the motor 6a, the motor 6b, and the motor 6c operates as a generator to produce an equal amount of electrical power and charge the energy storage device 4.

In another example, the wheel motor assembly 20 may decelerate from an operating speed using regenerative braking where each of the motor 6a, the motor 6b, and the motor 6c operates as a generator producing an amount of electrical power, and may operate asynchronously, to charge the energy storage device 4.

In another example, the wheel motor assembly 20 may decelerate from an operating speed using regenerative braking where no more than two of the group consisting of the motor 6a, the motor 6b, and the motor 6c operate as generators, whether synchronously or asynchronously, to produce electrical power and charge the energy storage device 4.

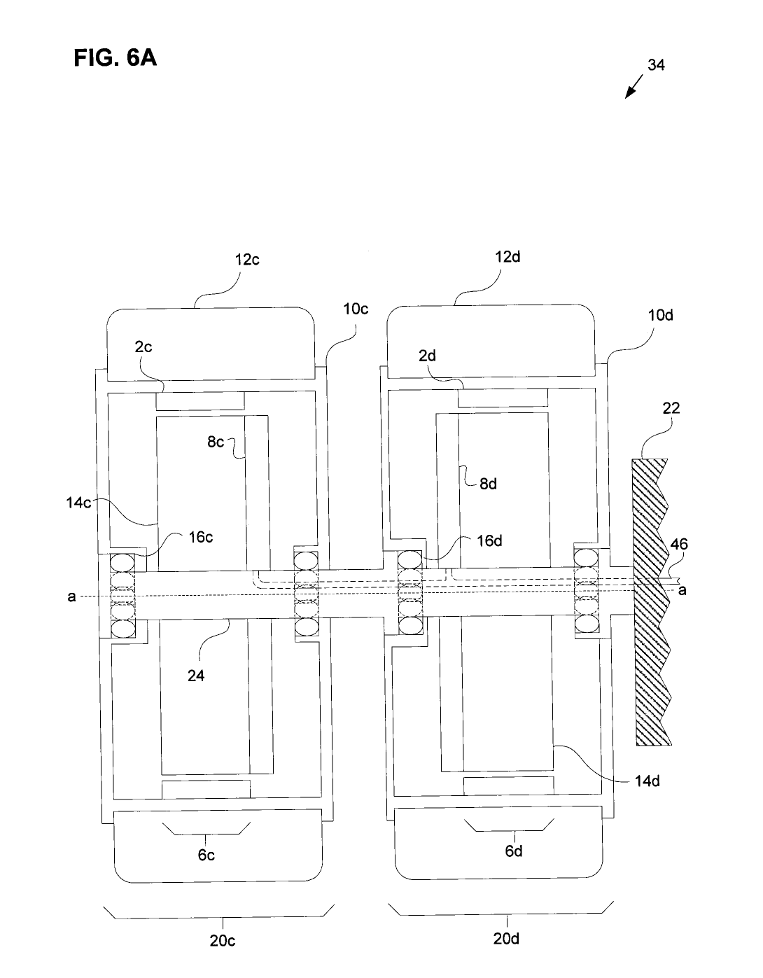

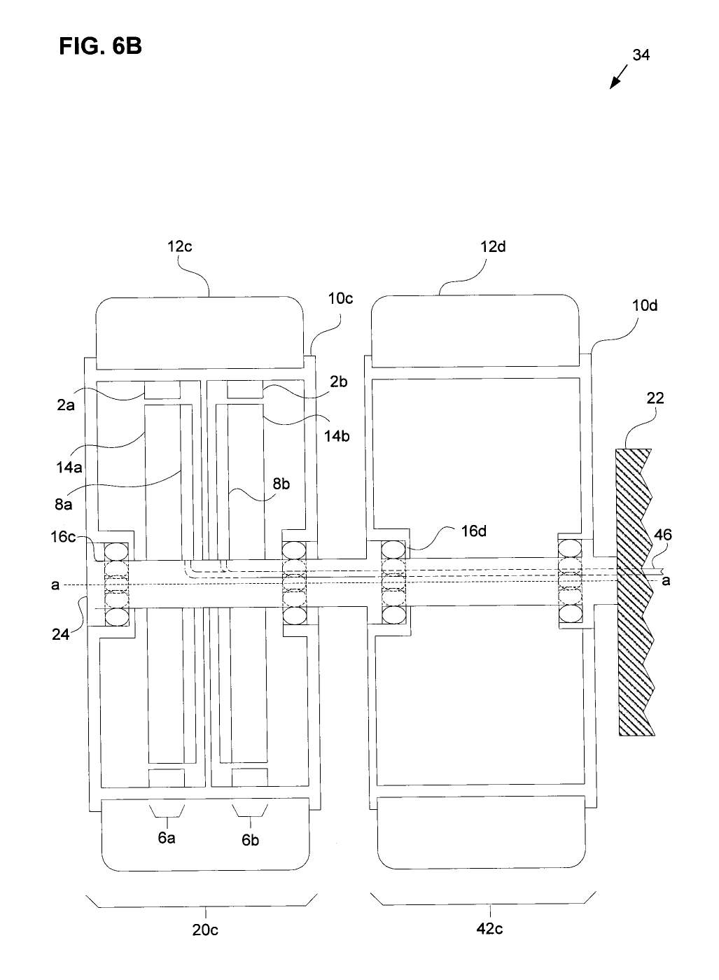

FIG. 6A is a front section view of an example embodiment of a wheelset 34, which is often found on vehicles such as heavy duty pickup trucks, medium and heavy duty trucks, truck trailers, buses, motor coaches, agricultural vehicles, and certain military vehicles, equipped with two wheel motor assemblies 20.

The wheelset 34 comprises a pair of wheel motor assemblies 20c and 20d connected to the chassis member 22, and a wire harness 46. Each of the wheel motor assembly 20c and the wheel motor assembly 20d are similar to the wheel motor assembly 20 described by FIG. 2, the difference being that both the wheel motor assembly 20c and the wheel motor assembly 20d are concentrically connected to an axle 24.

In this embodiment the wheel motor assembly 20c and the wheel motor assembly 20d are of an outer rotation type design.

The wheel motor assembly 20c comprises at least one bearing 16c, a plurality of magnets 2c, a stator 14c, a motor controller 8c, a wheel 10c, and a tire 12c. The stator 14c is centered about and rigidly connected to the axle 24. The axle 24 is rigidly connected to the chassis member 22 and does not rotate. The wheel 10c is connected to and supported by the at least one bearing 16c, and the wheel 10c is centered about and rotates around the axle 24. The plurality of magnets 2c are connected to an inside diameter of the wheel 10c, disposed similarly along the longitudinal axis a-a of the axle 24 as the stator 14c such that the plurality of magnets 2c rotate with the wheel 10c concentrically about the axle 24, and the stator 14c. Further, the tire 12c is concentrically connected to the wheel 10c.

The motor controller 8c, the stator 14c, and the plurality of magnets 2c form a motor 6c. A first end of the wire harness 46 is connected to the master controller 48 (FIG. 1), and a second end and a third end of the wire harness 46 are disposed within the axle 24 and connected to the motor controller 8c and a motor controller 8d, respectively. Electrical power provided to the motor 6c through the wire harness 46 results in rotation of the plurality of magnets 2c about the stator 14c. As the motor 6c receives sufficient electrical power to rotate about the axle 24, the wheel 10c and tire 12c also rotate and provide propulsion to the chassis member 22 of the vehicle 1. In the above example, the wheel motor assembly 20d is identical to the wheel motor assembly 20c, thus the description for the wheel motor assembly 20d is analogous to the preceding description of the wheel motor assembly 20c. Further, the motors 6c and 6d are able to rotate independently of the other, allowing for additional control methods for the vehicle 1. The vehicle may be equipped with a steering angle sensor to detect the vehicle path and cases where the wheel motor assembly 20c may need to travel at a faster rate than the wheel motor assembly 20d (or vice versa) to cover more distance around a curve. Further, a vehicle speed may be determined, for example from an average speed of at least some of the wheel motor assemblies 20 aboard the vehicle, and a vehicle threshold speed may be set to distinguish between cases. For example, above a vehicle threshold speed of 5 miles per hour (mph), regenerative braking may be performed. In another example, the vehicle threshold speed may be 10 mph.

Slip may also be determined from the difference in wheel speed between the wheel motor assembly 20c and the wheel motor assembly 20d. For example, slip of one wheel motor assembly may be indicated as a wheel speed difference between two wheel motor assemblies 20 of a wheelset 34 if the wheel speed difference is greater than an amount calculated based on the detected steering angle.

In one example, the tire 12c slips while the motor 6c accelerates or drives the wheel 10c, and the tire 12d does not slip while the motor 6d accelerates or drives the wheel 10d. The motor controller 8c may reduce power to the motor 6c while the motor controller 8d continues to power motor 6d if the tire 12d is not slipping, maintaining propulsion to the wheelset 34 as both the motor 6c and the motor 6d are located on and operate about the same axle 24. The reverse is also true during acceleration and propulsion if tire 12d slips instead of tire 12c.

In another example, the tire 12c slips while the motor 6c performs regenerative braking on the wheel 10c, and the tire 12d does not slip while the motor 6d performs regenerative braking on the wheel 10d. The motor controller 8c may reduce the magnitude of regenerative braking performed by the motor 6c while the motor controller 8d continues may perform regenerative braking performed by the motor 6d, maintaining regenerative braking of the wheelset 34 as both the motor 6c and the motor 6d are located on and operate about the same axle 24. The reverse is also true during regenerative braking if tire 12d slips instead of tire 12c.

As the wheelset 34 travels along a curved path, the tires 12c and 12d rotate at different speeds about the axle 24 due to their relative positions. In one example, the tire 12c must travel further than the tire 12d. The motor controller 8c may control the motor 6c to propel the wheel 10c at a faster rate than the rate the motor controller 8d controls the motor 6d to propel the wheel 10d, such that each tire 12c and 12d is driven on its respective path at the same rate of speed.

In another example, the tire 12d must travel further than the tire 12c. The motor controller 8d may control the motor 6d to propel the wheel 10d at a faster rate than the rate the motor controller 8c controls the motor 6c to propel the wheel 10c, such that each tire 12c and 12d is driven on its respective path at the same rate of speed.

As the wheelset 34 travels along a curved path, the tires 12c and 12d rotate at different speeds about the axle 24 due to their relative positions. In one example, the tire 12c must travel further than the tire 12d. The motor controller 8c may control the motor 6c to perform a different magnitude of regenerative braking about the wheel 10c than the magnitude of regenerative braking the motor controller 8d controls the motor 6d to perform about the wheel 10d, such that each tire 12c and 12d is subject to an equivalent magnitude of regenerative brake force for its respective path.

Further, the wheelset 34 may include varying motors 6c and 6d. In one example, the wheel motor assembly 20c and the wheel motor assembly 20d may each comprise a motor 6c and a 6d, respectively, of different sizes and designs.

In another example, at least one of the group consisting of the wheel motor assembly 20c and the wheel motor assembly 20d comprises a set of motors 6, wherein each set of motors 6 comprises at least two motors 6 of identical size and design, as described by FIG. 3.

In another example, at least one of the group consisting of the wheel motor assembly 20c and the wheel motor assembly 20d comprises a set of motors 6, wherein each set of motors 6 may comprise at least two motors 6 of different sizes and designs, as described by FIG. 4 and FIG. 5.

FIG. 6B is a front section view of an example embodiment of a wheelset 34. The wheelset 34 comprises a wheel motor assembly 20c and a wheel assembly 42c connected to the chassis member 22, and a wire harness 46. The wheel motor assembly 20c is similar to the wheel motor assembly 20 described by FIG. 3, and the wheel assembly 42c is similar to the wheel assembly 42 described by FIG. 2D, the difference being that both the wheel motor assembly 20c and the wheel assembly 42c are concentrically connected to an axle 24. In this embodiment the wheel motor assembly 20c is of an outer rotation type design and disposed further from the chassis member 22 than the wheel assembly 42c, though other embodiments may have the wheel motor assembly 20c closer to the chassis member 22 than the wheel assembly 42c.

The wheel motor assembly 20c comprises at least one bearing 16c, a plurality of magnets 2a, a plurality of magnets 2b, a motor controller 8a, a motor controller 8b, a stator 14a, a stator 14b, a wheel 10c, a tire 12c, and a wire harness 46.

The motor controller 8a is rigidly connected to the stator 14a, the motor controller 8b is rigidly connected to the stator 14b, and each is centered about and rigidly connected to the axle 24. The axle 24 is rigidly connected to the chassis member 22. The wheel 10c is connected to and supported by the at least one bearing 16c, and both the at least one bearing 16c and the wheel 10c are concentrically connected and rotate about the axle 24. The plurality of magnets 2a and the plurality of magnets 2b are connected to an inside diameter of the wheel 10c, disposed similarly along the longitudinal axis a-a of the axle 24 as the stator 14a and the stator 14b such that the plurality of magnets 2a and the plurality of magnets 2b rotate with the wheel 10c concentrically about the axle 24, the stator 14a, and the stator 14b, respectively. The tire 12c is concentrically connected to the wheel 10c. A first end of the wire harness 46 is connected to a master controller 48 (FIG. 1) and a second end and a third end of the wire harness 46 are disposed within the axle 24 and connected to the motor controller 8a and the motor controller 8b, respectively.

The stator 14a and the plurality of magnets 2a form a motor 6a. Electrical power provided to the motor 6a through the wire harness 46 results in rotation of the plurality of magnets 2a about the stator 14a. The stator 14b and the plurality of magnets 2b form a motor 6b. Electrical power provided to the motor 6b through the wire harness 46 results in rotation of the plurality of magnets 2b about the stator 14b. As one or both the motor 6a and the motor 6b receive sufficient electrical power to rotate, the wheel 10c and tire 12c also rotate and provide propulsion to the chassis member 22 of the vehicle 1. The wheel assembly 42c also turns with the wheel motor assembly 20c since it is connected to the same axle 24. The motor 6a and the motor 6b may operate synchronously or asynchronously.

In another example, the wheel motor assembly 20c comprises a set of motors 6, wherein the set of motors 6 may comprise at least two motors 6 of different sizes and designs, as described by FIG. 4 and FIG. 5.

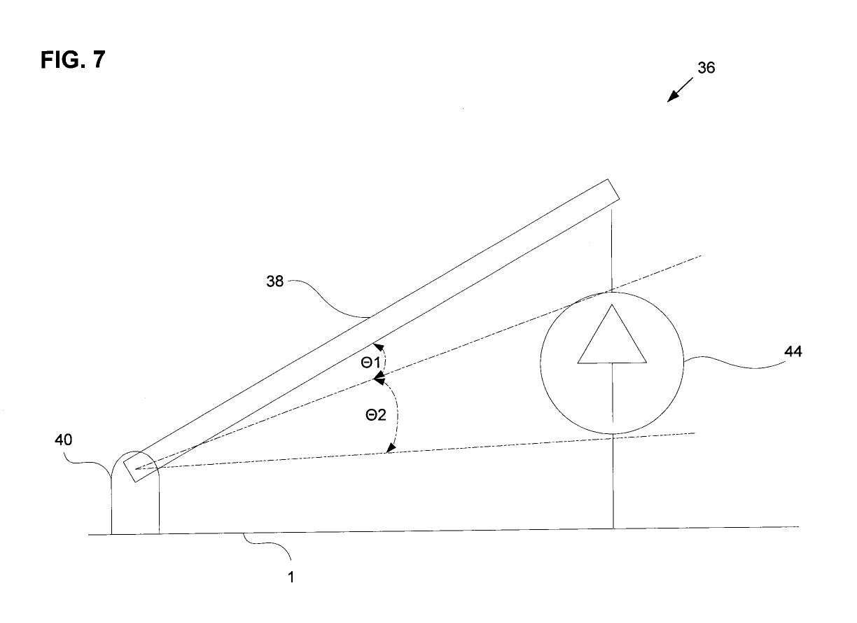

FIG. 7 is a side profile view of an example embodiment of a speed control device 36, the speed control device 36 comprising a foot pedal 38, a fulcrum 40, and a position sensor 44. The foot pedal 38 is connected at a first position to, and pivots about, the fulcrum 40 connected to the vehicle 1. The foot pedal 38 is connected at a second position to the position sensor 44 disposed between the foot pedal 38 and the vehicle 1.

The position of the foot pedal 38 may be displaced an amount between zero and 100 percent. As the foot pedal 38 is displaced, the position sensor 44 detects the position of the foot pedal 38. The position of the foot pedal 38 may be used by the master controller 48 (FIG. 1) to determine an amount of available electrical power to supply from the energy storage device 4 to a wheel motor assembly 20 of the vehicle 1. The amount of electrical power may be proportional to the displacement of the foot pedal 38, as detected by the position sensor 44, in a linear or non-linear manner.

In one example, the amount of electrical power provided corresponds in a linear manner with the position of the foot pedal 38. At fifty percent of possible displacement of the foot pedal 38, the master controller 48 provides the wheel motor assembly 20 with fifty percent of the available electrical power from the energy storage device 4.

In another example, the amount of electrical power provided corresponds in a non-linear manner with the position of the foot pedal 38. At fifty percent of possible displacement of the foot pedal 38, the master controller 48 provides the wheel motor assembly 20 with more than fifty percent of the available electrical power from the energy storage device 4.

In another example, the amount of electrical power provided corresponds in a non-linear manner with the wheel motor assembly 20 position of the foot pedal 38. At fifty percent of possible displacement of the foot pedal 38, the master controller 48 provides the wheel motor assembly 20 with less than fifty percent of the available electrical power from the energy storage device 4.

The position of the foot pedal 38 may also be used by the master controller 48 to determine a combination of motors 6 to operate.

In one example, the speed control device 36 is connected to a vehicle 1 equipped with a wheel motor assembly 20 comprising three motors 6a, 6b, and 6c. As the foot pedal 38 is displaced between zero and an angle Θ1, a first motor 6a powers the wheel motor assembly 20. As the foot pedal 38 is displaced between the angle Θ1 and an angle Θ2, a second motor 6b powers the wheel motor assembly 20. As the foot pedal 38 is displaced beyond the angle Θ2, a third motor 6c powers the wheel motor assembly 20.

In another example, as the foot pedal 38 is displaced between zero and the angle Θ1, the first motor 6a powers the wheel motor assembly 20. As the foot pedal 38 is displaced between the angle Θ1 and the angle Θ2, the first motor 6a and the second motor 6b power the wheel motor assembly 20. As the foot pedal 38 is displaced beyond the angle Θ2, the first motor 6a, the second motor 6b, and the third motor 6c power the wheel motor assembly 20.

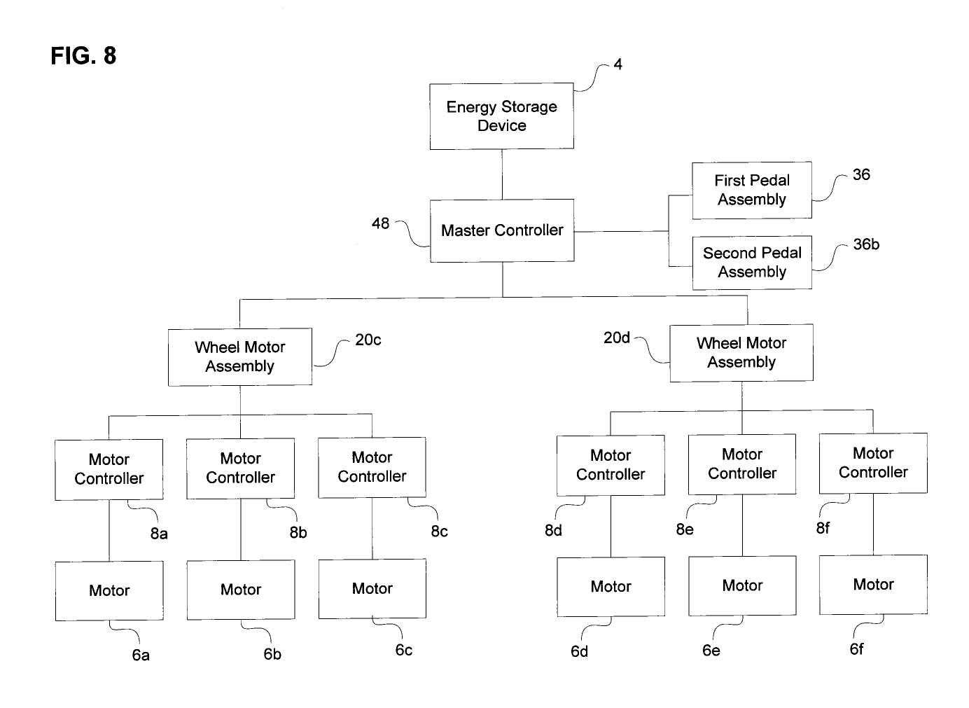

The various operating modes of the master controller 48 (described in FIG. 8) may be set to operate different combinations of motors 6 within a wheel motor assembly 20, depending on parameters including the magnitude of displacement of the foot pedal 38 when used as a throttle. The magnitude of displacement of the foot pedal 38 may be determined purely on an electrical basis.

Further, displacement of the foot pedal 38 may also have a mechanical feedback feature, for example a detent or variable stiffness feature, to provide feedback to the operator about the position of the foot pedal 38 and indicate a mode of operation of the wheel motor assembly 20.

Further, in another example the vehicle 1 is equipped with a second speed control device 36b connected to the motor controller 8 to control regenerative braking to charge the energy storage device 4. Displacement of the second foot pedal 38b is proportional to the magnitude of generation of electrical power. In addition to use for controlling regenerative braking, the second speed control device 36b may also be used to operate a mechanical or hydraulic brake circuit.

In one example, the speed control device 36 communicates with and controls the master controller 48 purely by means of electrical signals (“by wire), without a physical connection such as a throttle cable disposed between the speed control device 36 and the master controller 48 or the motor 6.

In another example, an actuation sensor 52 detects actuation of the speed control device assembly 36 and the second speed control device 36b. In such a case, the speed control device 36 is disabled by the actuation sensor 52 unless the second speed control device assembly 36b is not actuated.

In another example, the speed control device 36 may be a hand operated device and connected to a vehicle steering wheel.

In another example, the shape of the speed control device 36 may resemble various geometric shapes such as a rectangle, a square, an ellipse, or a circle.

Further, the second speed control device 36b may also be a hand operated device and connected to a vehicle steering wheel.

FIG. 8 is a system diagram of an example vehicle 1 including two wheel motor assemblies 20c and 20d, an energy storage device 4, a master controller 48, a speed control device 36, and a second speed control device 36b. The wheel motor assembly 20c comprises a motor controller 8a, a motor 6a, a motor controller 8b, a motor 6b, a motor controller 8c, and a motor 6c similar to that described by FIG. 5. The wheel motor assembly 20d is similar to the wheel motor assembly 20c.

The master controller 48 controls the distribution of electrical power between the energy storage device 4 and each of the wheel motor assemblies 20c and 20d based, in part, on the inputs of the first speed control device 36 and the second speed control device 36b. Each motor controller 8 controls the action of its corresponding motors 6.

The layout of the master controller 48 and a plurality of motor controllers 8 comprise at least one operating mode that varies the manner and magnitude of electrical power that is provided to the wheel motor assembly 20.

In one example, the wheel motor assemblies 20c and 20d are each equipped with two motors 6a and 6b as described by FIG. 3.

In another example, the wheel motor assemblies 20c and 20d are each equipped with two motors 6a and 6b as described by FIG. 4.

In another example, each wheel motor assembly 20c and 20d may be replaced by a wheelset 34 as described by FIG. 6A.

In another example, each wheel motor assembly 20c and 20d may be replaced by a wheelset 34 as described by FIG. 6B.

Further, the magnitude and distribution of electrical power provided from the energy storage device 4 may be varied by the master controller 48 based on data detected relating to at least one of a foot pedal 38 position, a vehicle 1 speed, a steering angle, a wheel 10 speed, a yaw, a roll, and a pitch of the vehicle 1, tire pressure, an activation status of other operator controlled settings including, where applicable, lighting, windshield wipers, suspension damping, and transmission gear.

Further, for a vehicle 1 equipped with more than one wheel motor assembly 20, the distribution of the electrical power provided by the master controller 48 may distributed between the set of wheel motor assemblies 20 in a variety of ways under various operating conditions.

In one case the vehicle 1 is equipped with two wheel motor assemblies 20 and the electrical power provided is distributed equally between them.

In another case the vehicle 1 is equipped with two wheel motor assemblies 20 and the electrical power provided is distributed unequally between them.

In another case the vehicle 1 is equipped with four wheel motor assemblies 20 and the electrical power provided is distributed equally between them.

In another case the vehicle 1 is equipped with four wheel motor assemblies 20 and the electrical power provided is distributed unequally between them.

Further, for each wheel motor assembly 20 equipped with more than one motor 6, the distribution of the electrical power provided to the wheel motor assembly 20 may be distributed in a variety of ways among the motors 6 of that wheel motor assembly 20.

In one mode, the wheel motor assembly 20 is equipped with at least two motors 6 as described by FIG. 3, FIG. 4, and FIG. 5, and the electrical power is distributed equally among the motors 6.

In another mode, the wheel motor assembly 20 is equipped with at least two motors 6 as described by FIG. 3, FIG. 4, and FIG. 5, and the electrical power is distributed unequally among the motors 6.

In another mode, the electrical power is distributed to at least one of the motors 6 in the wheel motor assembly 20.

The preceding descriptions of electrical power utilization of each of the wheel motor assemblies 20 and each of the motors 6 also applies to the contribution of electrical power produced by each of the wheel motor assemblies 20 and by each of the motors 6 equipped with the ability to generate electrical power during operation in a regenerative braking mode.

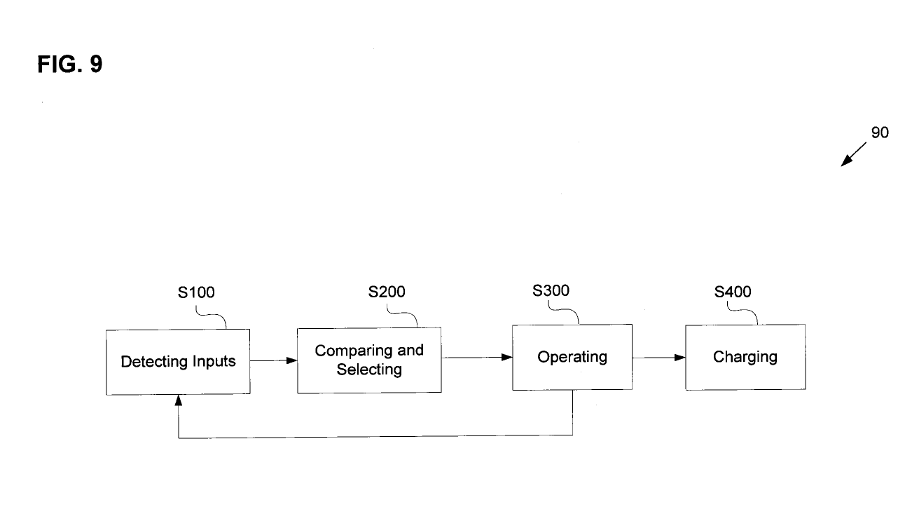

FIG. 9 is a diagram representing a sequence of primary processes of a wheel motor assembly control method 90 for controlling at least one wheel motor assembly 20 or wheelset 34. The wheel motor assembly control method 90 includes a detecting process S100, a comparing and selecting process S200, an operating process S300, and a charging process S400.

S100 represents a process of detecting input data from a plurality of sources aboard the vehicle 1, including data relating to at least one of a foot pedal 38 position, a vehicle 1 speed, a steering angle, a wheel 10 speed, a yaw, a roll, and a pitch of the vehicle 1, tire pressure, an activation status of other operator controlled settings including, where applicable, lighting, windshield wipers, suspension damping, and transmission gear.

S200 represents a process of comparing the data detected by S100 to a set of possible operating modes and settings based on the available wheel motor assemblies 20, the motors 6, energy stored in the energy storage device 4, and then prioritizing the operations of the wheel motor assemblies 20, the motors 6, and the energy storage device 4 to select the modes and settings most likely to provide the desired range performance, including efficiency, power, or other criteria.

S300 represents a process for operating the wheel motor assemblies 20, the motors 6, and the energy storage device 4 according to the modes and settings selected by the process of S200. Each motor 6 and each wheel motor assembly 20 has up to three primary modes of operation including propulsion (whether acceleration or steady-state operation), freewheeling, and regenerative, the modes of operation also described by the text of FIG. 5 and FIG. 8. Each mode of operation has a variety of settings based on the specification of the wheel motor assemblies 20, the motors 6, and the energy storage device 4, as well as the prevailing conditions. Further, the process S300 of operating the vehicle 1 provides the process S100 with data inputs by which to continue comparing and selecting modes of operation.

The process S400 represents a process for generating electrical power for charging the energy storage device 4. In a case where at least one motor 6 is operating in a regenerative mode in process S300, electrical power is harvested and transmitted to the energy storage device 4 and stored for later use by the charging process S400.

Additional operating conditions also exist including, in one example, the motor controller 8 detecting a case where the vehicle 1 is in coast down deceleration, the first speed control device 36 is not displaced and the speed of the vehicle 1 is greater than zero. The master controller 48 may compare the conditions to past scenarios or other data, select an operation, and signal a motor controller 8 to control at least one wheel motor assembly 20 in a power generation mode of process S300 and S400 to limit vehicle 1 speed to a speed and provide electrical power and charge the energy storage device 4.

In another example, the vehicle 1 is equipped with a second speed control device 36b, and the motor controller 8 detects a case where the vehicle 1 is stopped on an inclined surface in a drive mode, neither the first speed control device 36 or the second speed control device 36b is displaced, and the vehicle 1 has begun to roll. In that case the master controller may compares the magnitude of the acceleration and the incline and select an amount of electrical power to provide from the energy storage device 4 to operate at least one wheel motor assembly 20 to maintain the position of the vehicle 1 for an amount of time, preventing the vehicle 1 from rolling in either a forward or rearward direction. This is of particular benefit when the vehicle 1 is positioned on an incline and the operator momentarily releases the first speed control device 36 and the second speed control device 36b.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernable variants of the teachings herein, define, in part, the scope of the foregoing claim terminology such that no inventive subject matter is dedicated to the public.

What is claimed is:

1. A system for electrically driving a vehicle comprising:
an energy storage device connected to the vehicle;
a master controller connected to the energy storage device;
a speed control device connected to the master controller; and
a wheelset rotatably connected to an axle, the axle rigidly connected to the vehicle,
wherein a displacement of the speed control device is an input to the master controller based on which electrical power from the energy storage device is provided to the wheelset, rotating the wheelset about the axle, and providing propulsion to the vehicle,
wherein the wheelset further comprises a first wheel motor assembly and a second wheel motor assembly, the first wheel motor assembly comprises a first motor, the second wheel motor assembly comprises a second motor, and the first wheel motor assembly rotates at a speed different from that of the second wheel motor assembly in a case where the vehicle is traveling on a curved path.

2. The system for electrically driving a vehicle according to claim 1, further comprising:
a second speed control device and connected to the master controller;
wherein a displacement of the second speed control device is an input to the master controller based on which a wheel motor assembly of the wheelset generates electrical power and slows the vehicle, and transmits the electrical power through the master controller to charge the energy storage device.

3. A method for electrically operating a vehicle equipped with a wheelset comprising a first wheel motor assembly and a second wheel motor assembly, a first speed control device, and a second speed control device, the method comprising:
comparing a vehicle speed and the position of at least one of the first speed control device and the second speed control device and selecting a mode of operation;
detecting a difference in rotational speed between the first wheel motor assembly and the second wheel motor assembly;
reducing electrical power to at least one of the first wheel motor assembly and the second wheel motor assembly in a case where the first speed control device is not depressed, the second speed control device is not depressed, and the vehicle speed is above a predetermined threshold speed;
generating electrical power at a first magnitude with the first wheel motor assembly and at a second magnitude with the second wheel motor assembly to charge an energy storage device, in a case where the first pedal is not depressed, the second pedal is depressed, and the vehicle speed is above a predetermined threshold speed, wherein the first magnitude may not be equal to the second magnitude;
accelerating the first wheel motor assembly at a first magnitude and accelerating the second wheel motor assembly at a second magnitude, in a case where the first pedal is depressed and the second pedal is not depressed, wherein the first magnitude may not be equal to the second magnitude.

4. The method according claim 3, further comprising:
detecting the vehicle is accelerating from a stop;
operating the at least one motor in the wheel motor assembly to resist acceleration of the vehicle in a case where the first speed control device is not depressed and the second speed control device is not depressed.

5. A method for electrically operating a vehicle equipped with a wheelset comprising a first wheel motor assembly and a second wheel motor assembly, a first speed control device, a second speed control device, and a steering angle sensor, the method comprising:
comparing a wheel speed of the first wheel motor assembly to a wheel speed of the second wheel motor assembly;
detecting a steering angle with the steering angle sensor;
determining if the vehicle is on a curve;
determining if the first wheel motor assembly is traveling a further distance than the second wheel motor assembly is traveling; and
determining if there is slip between the first wheel motor assembly and the second wheel assembly.

6. The method of claim 5 further comprising:
driving the first wheel motor assembly at a faster rate of speed than the second wheel motor assembly in a case where the first wheel motor assembly is traveling a further distance than the second wheel motor assembly, as detected by the steering angle sensor, the first speed control device is depressed, and the second speed control device is not depressed.

7. The method of claim 5 further comprising:
driving the second wheel motor assembly at a faster rate of speed than the first wheel motor assembly in a case where the second wheel motor assembly is traveling a further distance than the first wheel motor assembly, as detected by the steering angle sensor, the first speed control device is depressed, and the second speed control device is not depressed.

8. The method of claim 5 further comprising:
generating a first magnitude of electrical power with the first wheel motor assembly that is less than a second magnitude of electrical power with the second wheel motor assembly in a case where the first wheel motor assembly is traveling a further distance than the second wheel motor assembly, the vehicle speed is above a predetermined threshold speed, as detected by the steering angle sensor, and the second speed control device is depressed.

9. The method of claim 5 further comprising:
generating a first magnitude of electrical power with the first wheel motor assembly that is greater than a second magnitude of electrical power with the second wheel motor assembly in a case where the first wheel motor assembly is traveling a shorter distance than the second wheel motor assembly, the vehicle speed is above a predetermined threshold speed, as detected by the steering angle sensor, and the second speed control device is depressed.

10. The method of claim 5 further comprising:
providing power to the first wheel motor assembly; and
reducing power to the second wheel motor assembly, in a case where the second wheel motor assembly is slipping.

11. The method of claim 5 further comprising:
generating power with the first wheel motor assembly; and
reducing power to the second wheel motor assembly, in a case where the second wheel motor assembly is slipping.
